(19) United States
(12) Patent Application Publication
(10) Pub. No.: US 2026/0310650 A1
(43) Pub. Date: Oct. 8, 2026

(54) AUTO-MAINTENANCE OF VECTOR INDEXES

(71) Applicant: Google LLC, Mountain View, CA (US)

(72) Inventors: Vaibhav Jain, Bengaluru (IN); Pushkar Bhushan Khadilkar, Pune (IN); Yannis Papakonstantinou, La Jolla, CA (US); Wing Hang Li, Santa Clara, CA (US)

(21) Appl. No.: 19/640,207

(22) Filed: Apr. 6, 2026

(30) Foreign Application Priority Data
Apr. 8, 2025 (IN) 202541034375

(51) Int. Cl. G06F 16/23; G06F 16/22

(52) U.S. Cl. CPC G06F 16/2343; G06F 16/2272; G06F 16/2237

(57) ABSTRACT

A computing system may apply a shared lock to a partition included in an index. The shared lock may allow concurrent read operations on the partition and may prevent concurrent write operations on the partition. While applying the shared lock, the computing system may determine, based on metadata, whether to apply a maintenance operation to the partition. Responsive to determining to apply the maintenance operation to the partition, the computing system may release the shared lock. The computing system may monitor a pin count for the partition to determine when all concurrent read operations on the partition are finished, and may apply a cleanup lock in response to determining all concurrent read operations are finished. While applying a cleanup lock to the partition, the computing system may apply the maintenance operation to the partition. The cleanup lock may prevent concurrent read operations and concurrent write operations on the partition.

### CROSS REFERENCE TO RELATED APPLICATION

This application claims the benefit of IN Provisional Patent Application No. 202541034375, filed 8 Apr. 2025, the entire contents of which is incorporated herein by reference.

### BACKGROUND

When searching through a large dataset of vectors (e.g., video embeddings, text embeddings, image features), a vector index may be used to help quickly find most similar vectors. Vector indexes may have close-to-optimal structure when they are first built with sufficient data. In an operational database, however, the dataset may not be static, and customer applications may continue to perform data manipulation language (DML) operations, such as inserting new data, updating the dataset with additional or newer data, and deleting stale or old data. If the vector index does not adapt, i.e., is not incrementally updated, with the underlying dataset changes, vector search queries served by the index may start to suffer from poor performance and bad recall.

### SUMMARY

In general, techniques of this disclosure are directed to automatic maintenance of vector indexes. In some examples, index maintenance can be done in the foreground (i.e., by a user issuing a command when they want maintenance done), or automatically through background processes. An example computing system may include a background worker process-based framework that can periodically scan the indexes and perform the index maintenance inline. During index maintenance, the computing system may split a large partition (e.g., a node, cluster or centroid) into two smaller partitions, such as to rebalance the index for better performance as data grows. Queries or insertions that occur outside the maintenance window (i.e., before the split starts or after it completes) may observe a consistent tree state (e.g., a stable, consistent index structure). However, queries or insertions that overlap with the index maintenance (e.g., queries or insertions that occur during the split) may encounter a transient, otherwise impossible state (e.g., an inconsistent index structure). This is a common challenge in concurrent systems, such as vector databases or real-time systems that need to maintain consistency for queries, but also aim to rebalance or optimize parts of the index in the background. As such, when scanning a plurality of partitions included in an index, the example computing system may apply a shared lock to a first partition from the plurality of partitions that the computing system plans to inspect. In general, the shared lock may allow concurrent read operations on the first partition and prevent concurrent write operations on the first partition. That is, concurrent queries may continue to read from the first partition while the shared lock is applied. While applying the shared lock to the first partition, the computing system may determine, based on index metadata, whether to apply a maintenance operation to the first partition. For example, the computing system may determine whether the first partition is too full and should be a target partition for a split operation. Responsive to determining to apply the maintenance operation to the first partition, the computing system may release the shared lock and monitor a pin count for the first partition (e.g., the pin count may indicate a number of query, insert, and/or vacuum processes that are using the first partition). Responsive to determining all concurrent read operations on the first partition are finished (e.g., when the pin count is equivalent to 1), the computing system may apply a cleanup lock to the first partition. In general, the cleanup lock may prevent concurrent read operations on the first partition and prevent concurrent write operations on the first partition. While applying the cleanup lock to the first partition, the computing system may apply the maintenance operation to the first partition.

In one example, the disclosure is directed toward a method that includes, while applying a shared lock to a first partition from a plurality of partitions included in an index, determining, by the computing system, and based on metadata, whether to apply a maintenance operation to the first partition. The method further includes, responsive to determining to apply the maintenance operation to the first partition: releasing, by the computing system, the shared lock, and, while applying a cleanup lock to the first partition, applying, by the computing system, the maintenance operation to the first partition, wherein the cleanup lock prevents concurrent read operations on the first partition and prevents concurrent write operations on the first partition.

In another example, the disclosure is directed toward a computing device that includes one or more processors, and one or more storage devices that store instructions. The instructions, when executed by the one or more processors, cause the one or more processors to, while applying a shared lock to a first partition from a plurality of partitions included in an index, determine, based on metadata, whether to apply a maintenance operation to the first partition. The instructions further cause the one or more processors to, responsive to determining to apply the maintenance operation to the first partition: release the shared lock, and, while applying a cleanup lock to the first partition, apply the maintenance operation to the first partition, wherein the cleanup lock prevents concurrent read operations on the first partition and prevents concurrent write operations on the first partition.

In yet another example, the disclosure is directed toward a non-transitory computer-readable storage medium encoded with instructions. The instructions, when executed by one or more processors, cause one or more processors to, while applying a shared lock to a first partition from a plurality of partitions included in an index, determine, based on metadata, whether to apply a maintenance operation to the first partition. The instructions further cause the one or more processors to, responsive to determining to apply the maintenance operation to the first partition: release the shared lock, and, while applying a cleanup lock to the first partition, apply the maintenance operation to the first partition, wherein the cleanup lock prevents concurrent read operations on the first partition and prevents concurrent write operations on the first partition.

In yet another example, the disclosure is directed toward a computer program product for automatic maintenance of vector indexes. The computer program product includes instructions that, when executed by one or more processors, cause the one or more processors to, while applying a shared lock to a first partition from a plurality of partitions included in an index, determine, based on metadata, whether to apply a maintenance operation to the first partition. The instructions further cause the one or more processors to, responsive to determining to apply the maintenance operation to the first partition: release the shared lock, and, while applying a cleanup lock to the first partition, apply the maintenance operation to the first partition, wherein the cleanup lock prevents concurrent read operations on the first partition and prevents concurrent write operations on the first partition.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing system configured to apply index maintenance operations, in accordance with one or more techniques of this disclosure.

FIG. 2 is a block diagram illustrating another example computing system configured to apply index maintenance operations, in accordance with one or more techniques of this disclosure.

FIG. 3 is a flowchart illustrating an example operation of a computing system for applying index maintenance operations, in accordance with one or more techniques of this disclosure.

### DETAILED DESCRIPTION

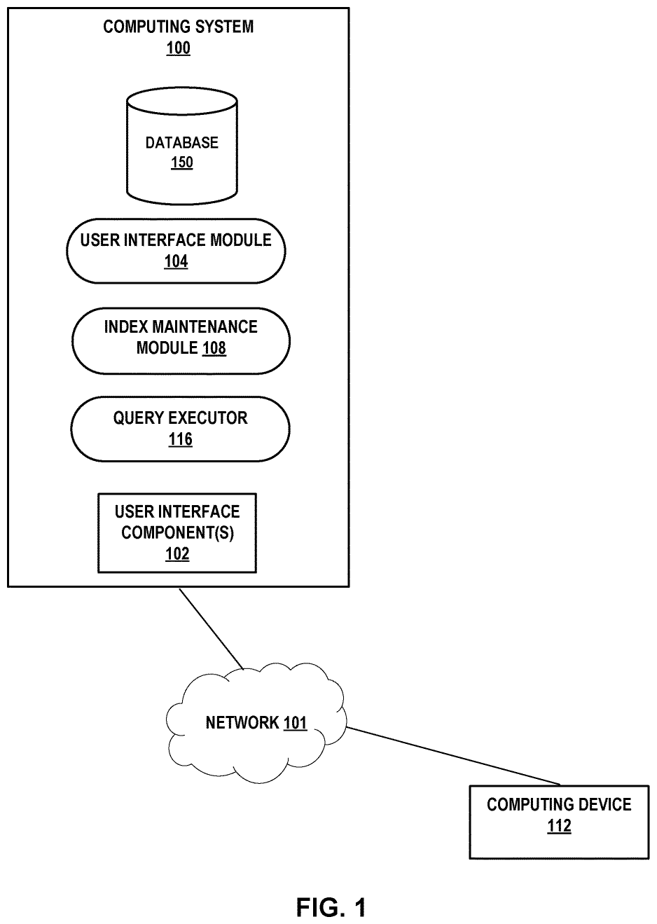

FIG. 1 is a conceptual diagram illustrating an example computing system for applying index maintenance operations, in accordance with one or more techniques of this disclosure. In the example of FIG. 1, a user 120 interacts with computing device 112 that is in communication with computing system 100. In some examples, some or all of the components and/or functionality attributed to computing system 100 may be implemented or performed by computing device 112.

While not explicitly shown in the example of FIG. 1, computing system 100 may be implemented on a plurality of computing devices that may include, but are not limited to, portable, mobile, or other devices, such as mobile phones (including smartphones), laptop computers, desktop computers, tablet computers, smart television platforms, automobile platforms, server computers, mainframes, a gaming system, a media player, an e-book reader, an automobile navigation system, a virtual reality (VR) device, an augmented reality (AR) device, AR/VR glasses, a wearable computing device (e.g., a computerized watch, computerized eyewear such as AI glasses, a computerized glove, a computerized ring, etc.), or any other type of mobile or non-mobile computing device. In some examples, computing system 100 may represent a cloud computing system that provides one or more services via network 101. That is, in some examples, computing system 100 may be a distributed computing system.

Computing system 100 may communicate with computing device 112 via network 101. Network 101 may include any public or private communication network, such as a cellular network, Wi-Fi network, a direct cell-to-satellite communication network, or other type of network for transmitting data between computing system 100 and computing device 112. In some examples, network 101 may represent one or more packet switched networks, such as the Internet. Computing device 112 may send and receive data to and from computing system 100 across network 101 using any suitable communication techniques. For example, computing system 100 and computing device 112 may each be operatively coupled to network 101 using respective network links. Network 101 may include network hubs, network switches, network routers, etc., that are operatively inter-coupled thereby providing for the exchange of information between computing device 112 and computing system 100. In some examples, network links of network 101 may be Ethernet, ATM or other network connections. Such connections may include wireless and/or wired connections.

As shown in the example of FIG. 1, computing system 100 includes one or more user interface (UI) components (“UI components 102”). UI components 102 of computing system 100 may be configured to function as input devices and/or output devices for computing system 100. UI components 102 may be implemented using various technologies. For instance, UI components 102 may be configured to receive input from a user through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitance touchscreen, a pressure sensitive screen, an acoustic pulse recognition touch screen, or another presence-sensitive technology. That is, UI components 102 of computing system 100 may include a presence-sensitive device that may receive tactile input from a user. UI components 102 may receive indications of the tactile input by detecting one or more gestures from a user (e.g., when a user touches or points to one or more locations of UI components 102 with a finger or a stylus pen).

UI components 102 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user. Additional examples of an output device include a speaker, a haptic device, or other device that can generate intelligible output to a user. For instance, UI components 102 may present output to a user as a graphical user interface (“GUI”) that may be associated with functionality provided by computing system 100. In this way, UI components 102 may present various user interfaces of applications executing at or accessible by computing system 100 (e.g., an electronic message application, an Internet browser application, etc.). A user may interact with a respective user interface of an application to cause computing system 100 to perform operations relating to a function provided by the application.

In some examples, UI components 102 of computing system 100 may detect two-dimensional and/or three-dimensional gestures as input from a user. For instance, a sensor of UI components 102 may detect the user's movement (e.g., moving a hand, an arm, a pen, a stylus, etc.) within a threshold distance of the sensor of UI components 102. UI components 102 may determine a two- or three-dimensional vector representation of the movement and correlate the vector representation to a gesture input (e.g., a hand-wave, a pinch, a clap, a pen stroke, etc.) that has multiple dimensions. In other words, UI components 102 may, in some examples, detect a multidimensional gesture without requiring the user to gesture at or near a screen or surface at which UI components 102 output information for display. Instead, UI components 102 may detect a multi-dimensional gesture performed at or near a sensor which may or may not be located near the screen or surface at which UI components 102 output information for display.

In the example of FIG. 1, computing system 100 includes user interface (UI) module 104. UI module 104 may perform operations described herein using hardware, software, firmware, or a mixture thereof residing in and/or executing at computing system 100. Computing system 100 may execute UI module 104 with one processor or with multiple processors. In some examples, computing system 100 may execute UI module 104 as a virtual machine executing on underlying hardware. UI module 104 may execute as one or more services of an operating system or computing platform or may execute as one or more executable programs at an application layer of a computing platform.

UI module 104, as shown in the example of FIG. 1, may be operable by computing system 100 to perform one or more functions, such as receive input and send indications of such input to other components associated with computing system 100. UI module 104 may also receive data from components associated with computing system 100. Using the data received, UI module 104 may cause other components associated with computing system 100, such as UI components 102, to provide output based on the data.

In some examples, computing system 100 may be a cloud computing system (e.g., a high-performance remote server or cluster of high-performance remote servers) in communication with one or more client computing devices, such as computing device 112, via a network 101. In some examples, computing device 112 may submit one or more queries (e.g., via an SQL interface or the like) to computing system 100. Computing device 112 may be any computing device, such as a desktop workstation, a laptop workstation, or a mobile device (i.e., a smart phone).

As such, in general, computing system 100 may be configured to execute queries for a database such as database 150. That is, computing system 100 may include query executor 116, which may execute a query against database 150. In some examples, computing system 100 includes a process-based query system (i.e., a PostgreSQL based system). In some examples, query executor 116 may store data related to a query in a shared memory before, during, and/or after execution of the query. In general, query executor 116 may perform both read and write operations. Although FIG. 1 only includes database 150, query executor 116 may execute queries for any number of databases included in or accessible by computing system 100. In general, database 150 may store a variety of data, including, but not limited to, data tables, indexes, schemas, metadata, views, triggers, stored procedures, system catalogs, and transaction logs. For example, in accordance with the techniques described herein, database 150 may include an index, i.e., a data structure that facilitates faster searching in database 150. That is, when query executor 116 receives a query, query executor 116 may search database 150 using its index. Example index types include, but are not limited to, B-Tree, Hash, GIN/BRIN, and vector indexes (e.g., IVF, HNSW).

As shown in the example of FIG. 1, computing system 100 may include index maintenance module 108. In general, index maintenance module 108 may facilitate automatic maintenance of vector indexes. In some examples, index maintenance can be done in the foreground (i.e., by a user of computing device 112 issuing a command when they want maintenance done), or automatically through background processes. In the example of FIG. 1, index maintenance module 108 may be or include a background worker process-based framework that can periodically scan indexes and perform index maintenance inline. During index maintenance, index maintenance module 108 may split a large partition (e.g., a node, cluster or centroid) into two smaller partitions, such as to rebalance the index for better performance as data grows (e.g., as database 150 grows larger).

In general, queries or insertions that occur outside the maintenance window (i.e., before the split starts or after it completes) may observe a consistent tree state (e.g., a stable, consistent index structure). However, queries or insertions that overlap with the index maintenance (e.g., queries or insertions that occur during the split) may encounter a transient, otherwise impossible state (e.g., an inconsistent index structure). This is a common challenge in concurrent systems, such as vector databases or real-time systems that need to maintain consistency for queries, but also aim to rebalance or optimize parts of the index in the background.

For example, in a range or similarity search, query executor 116 may scan a partition, but while that scan is happening, the partition may be undergoing a split by a maintenance process facilitated by index maintenance module 108. The scan pointer, which may be pointing to a location in the old (pre-split) partition, may run into various issues, such as the scan pointer now pointing to moved data, the two smaller partitions having copies of the same data (e.g., vectors), one partition being half-full and the other partition being empty, and/or the routing logic being mid-update. As such, in accordance with the techniques described herein, computing system 100 may include logic to handle the split safely without corrupting results.

In general, the source leaf node or partition may be the existing leaf node or partition being split, and the target leaf node or partition may be the leaf node or partition created by the split. In general, at any given time, each leaf node or partition may exist in one of the following states: “unchanged” state (e.g., the partition is not undergoing maintenance), “split source” state (e.g., the partition is the source of the split, in which some rows are actively copied to another partition), “split target” state (e.g., a partition is growing and may contain some rows still present in the source partition, and may transition to the unchanged state after receiving all its rows. The target partition may directly start in this state), and “split source cleanup” state (e.g., rows belonging to the target partition are being deleted, and the rows which belong to the source partition post-split continue to remain. The source partition may transition to the unchanged state after all rows belonging to the target partition are deleted).

Throughout this disclosure, “query” may refer to both queries and inserts. In some examples, query concurrency may require determining if a query accessed a partition in a specific state. Since a partition's state can change during a query scan, “accessed a partition in a specific state” may mean the partition held that specific state at some point during the scan. In general, a query may scan a partition completely from start to finish. In general, a query may source a shared latch on a partition page during scanning, as does the split process. In general, a split may move rows; otherwise, it may be a no-operation without concurrency issues. In general, row deletion/insertion may occur under an exclusive lock. In general, both query and maintenance scans may follow page order, and the start page of the partition may not change.

In some examples, a partition's state may be verified with index maintenance metadata. For instance, the index split metadata may contain split information. However, this metadata may be separate from the index data pages, and there may be no locking between partition state changes and metadata updates. For example, if a query checks the metadata at the start and end of a partition scan, the metadata could change in between. Checking the metadata for every query is expensive, especially since splits should be infrequent.

That is, to address the transient state, the techniques described herein may involve splitting large partitions (e.g., large centroids) and updating partitions using locks and index metadata. Specifically, when scanning a plurality of partitions included in an index of database 150, index maintenance module 108 may apply a shared lock to a first partition from the plurality of partitions that index maintenance module 108 plans to inspect. In general, the shared lock may allow query executor 116 to continue executing concurrent read operations on the first partition, but may prevent query executor 116 from executing concurrent write operations on the first partition. That is, concurrent queries may continue to read from the first partition while the shared lock is applied.

While applying the shared lock to the first partition, index maintenance module 108 may determine, based on index metadata (which may be stored in database 150), whether to apply a maintenance operation to the first partition. For example, index maintenance module 108 may determine whether the first partition is too full and should be a target partition for a split operation. Responsive to determining to apply the maintenance operation to the first partition, index maintenance module 108 may release the shared lock and monitor a pin count for the first partition (e.g., the pin count may indicate a number of processes being executed by query executor 116 that are using the first partition).

Responsive to determining all concurrent read operations on the first partition are finished (e.g., when the pin count is equivalent to 1), index maintenance module 108 may apply a cleanup lock to the target partition. In general, the cleanup lock may prevent concurrent read operations on the first partition and prevent concurrent write operations on the first partition. While applying the cleanup lock to the first partition, index maintenance module 108 may apply the maintenance operation to the first partition.

As such, in general, the techniques described herein may involve an automated background process that uses a set of tunable heuristics, such as query performance, recall, and dataset changes, to decide which partitions require maintenance. Because split is an intrusive operation, additional metadata may be stored in the index to ensure that splits are crash safe and can be restarted/resumed post-restart. Furthermore, the techniques described herein may provide solutions for handling concurrent queries, such that rows are not missed and duplicate rows are not returned while the split is in progress. That is, the index maintenance described herein may support safer splitting and updating of large centroids. In this way, the techniques described herein may provide solutions for adapting dynamic datasets in operational databases, such that performance and recall of vector search queries served by the index may be improved.

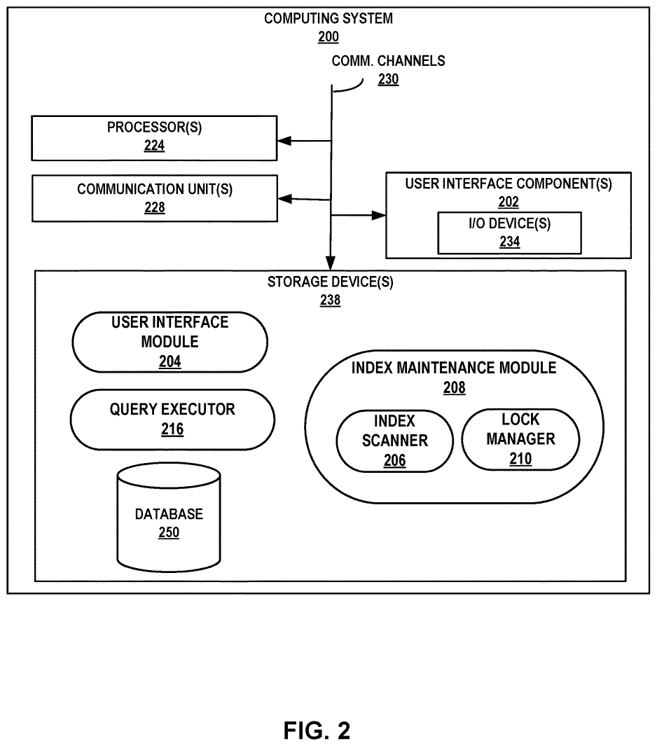

FIG. 2 is a block diagram illustrating another example computing system configured to apply index maintenance operations, in accordance with one or more techniques of this disclosure. As shown in the example of FIG. 2, computing device 200 includes processors 224, one or more communication channels 230, one or more user interface components (UIC) 202, one or more communication units 228, and one or more storage devices 238. Storage devices 238 of computing device 200 may include user interface module 204, query executor 216, database 250, and index maintenance module 208, which may similar if not substantially similar to user interface module 104, query executor 116, database 150, and index maintenance module 108 of FIG. 1, respectively. As shown in the example of FIG. 2, index maintenance module 208 further includes index scanner 206, lock manager 210, and WAL manager 214. Some or all of the components and/or functionality attributed to computing device 200 may be implemented or performed by another computing device and/or computing system in communication with computing device 200.

The one or more communication units 228 of computing device 200, for example, may communicate with external devices by transmitting and/or receiving data at computing device 200, such as to and from remote computer systems or computing devices. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection), one or more inter-process communication data structures, or any other components for communicating data between hardware and/or software locally or remotely.

One or more I/O devices 234 of computing device 200 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

User interface module 204, index maintenance module 208, and query executor 216 may perform operations described herein using software, hardware, firmware, or a mixture of hardware, software, and firmware residing in and executing on computing device 200 or at one or more other computing devices (e.g., a cloud-based application-not shown). For example, some or all of modules of FIG. 2 may be included in and executable on another local computing device in communication with computing device 200, e.g., via a local network.

Computing device 200 may execute one or more of the modules included in FIG. 2 with one or more processors 224 or may execute any or part of one or more of the modules included in FIG. 2 as or within a virtual machine executing on underlying hardware. One or more of the modules included in FIG. 2 may be implemented in various ways, for example, as a downloadable or pre-installed application, remotely as a cloud application, or as part of the operating system of computing device 200. Other examples of computing device 200 that implement techniques of this disclosure may include additional components not shown in FIG. 2.

In the example of FIG. 2, one or more processors 224 may implement functionality and/or execute instructions within computing device 200. For example, one or more processors 224 may receive and execute instructions that provide the functionality of UIC 202, communication units 228, one or more storage devices 238 and an operating system to perform one or more operations as described herein. For example, one or more processors 224 may receive and execute instructions that provide the functionality of some or all of the modules included in FIG. 2 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing device 200 may store information, such as information retrieved from a user computing device, or other data discussed herein, for processing during the operation of computing device 200. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules included in FIG. 2.

In general, database 250 may store at least one index structure for fast lookup of rows included in database 250. For example, a tree-based index structure before a maintenance operation (e.g., a “split centroid” or “split” operation, which may be used interchangeably throughout this disclosure) may include an internal centroid or non-leaf node or otherwise partition “p1” that points to one or more children (e.g., leaf nodes or partitions “p2,” “p3,” “p4,” etc.) that each contain rows, e.g., numeric values such as vector IDs or keys. In general, “node,” “centroid” and “partition” may be used interchangeably throughout this disclosure. In general, the source leaf node or partition may be the existing leaf node or partition being split, and the target leaf node or partition may be the leaf node or partition created by the split. In general, at any given time, each leaf node or partition may exist in one of the following states: “unchanged” state (e.g., the partition is not undergoing maintenance), “split source” state (e.g., the partition is the source of the split, in which some rows are actively copied to another partition), “split target” state (e.g., a partition is growing and may contain some rows still present in the source partition, and may transition to the unchanged state after receiving all its rows. The target partition may directly start in this state), and “split source cleanup” state (e.g., rows belonging to the target partition are being deleted, and the rows which belong to the source partition post-split continue to remain. The source partition may transition to the unchanged state after all rows belonging to the target partition are deleted).

In general, database 250 may also store index maintenance metadata, which may include information pertaining to the average number of vectors per centroid during build, as well as information pertaining to states of various partitions, which may be used to verify that a partition is not the source or target of an ongoing maintenance operation (e.g., a split). Other metadata that may be stored in database 250 may include information pertaining to pointers to the source and target partitions while a split is in progress. In general, maintenance-related metadata may be stored as entries on a maintenance metadata page stored in database 250. The maintenance metadata page may include a variable number of metadata items for various purposes, such as a split centroid operation (e.g., splitting a large partition into k new partitions and redistributing the points in the original partition), an “update centroid” operation (e.g., updating the centroid of a node when the points in the children node change, such as leaf level updates that require updating internal node centroids). “re-residualization (e.g., the items in the partition may be stored with residualization (value stored=point-centroid) for quantizations such as AH. If the centroid changes, the values for individual points are not updated, then the distance computation may be affected, and thus whether re-residualization is required should be evaluated), and “reassign” (e.g., reassigning the items from the largest partition to the tree, which may be a “global” update). In general, the split centroid operation may be useful for data-skews when all the newly inserted rows are going to a small subset of partitions, and/or when a dataset has grown and all the existing centroids have grown proportionally, thus causing the index structure to be different from how it was initially created.

In general, various metadata may be stored in database 250. For instance, for centroid identification, pointers to the old & new centroid while a split is in progress may be stored. This information may be stored in the maintenance metadata page linked from a root metadata page. In some examples, the information required for a split may be page_id (4 bytes), row number (2 bytes) for each partition, and/or additional bytes for status, tags, etc. Thus, in some examples, a total of at least 16 bytes of metadata may be required per split operation. In some examples, this information may not be stored on the metadata page as it has limited space, and instead a new page pointer maintenance metadata page may be added to the metadata page to store maintenance-related metadata.

Since there may be a new page created for maintenance metadata, a new storage format may be defined for it. In some examples, the maintenance metadata page format may be extensible and may use a standard slotted page format. In some examples, the page may include a variable number of metadata items. For instance, an ItemId line pointer array may point to individual metadata items. In some examples, the individual metadata entries may fit on a single page. In general, a metadata page can store metadata items for various purposes (for example, SplitCentroid, UpdateCentroid operations). Metadata for a particular type may be expected (but not required) to be of fixed size, and the size may vary across different metadata types. For example, metadata for split operation may not be equivalent to the size of an update operation.

Since the internal details of metadata structure may not yet be known, the structure may be generic, e.g., may involve a tag based structure with a tag as a first field. The rest of the metadata may be interpreted based on the tag value. For instance, “PageHeaderData” may be used as the standard PostgreSQL page header, and a special space may include a structure with “version,’ “next_page_id” (which may allow a chain of metadata pages), “flags,” “unused1,” etc. If a page in the metadata chain becomes empty, it may be deleted. In some examples, the initial version may only support deleting the last empty page. In some examples, the pointer in the root metapage for the index may point to the first metadata page. In some examples, the general metadata entry may have a specific format. In some examples, the size of the record may be stored in a PostgreSQL Item Id or line pointer such that it does not have to be stored in the metadata entry structure.

In some examples, some of the metadata changes may require updating the index metapage. For instance, indexes may have been created with a current index version, and thus some changes may be required for the existing indexes to allow maintenance operations. The tree index metadata root page may be zeroed when it is allocated, and the value 0 may not be a valid value for any page other than the main metadata page, which may be used to transparently add new maintenance pages for existing instances. For instance, a new field “maintenance_metadata_page_id” may have a value of 0 on older indexes, and a set value on new indexes. For older indexes, the first maintenance operation may allocate a page and set this value.

In some examples, query executor 216 may use the internal pages of database 250 to identify the candidate leaf partitions containing the actual vector. All data points in a selected leaf partition may be scanned by query executor 216 to identify the approximate nearest neighbors. Internal nodes may not increase in size or acquire new entries, and inserts or updates on a data row may translate into inserts into the leaf partitions of the index. In some examples, insert page metadata stored in an internal level above the leaf pages may be updated when a new insert page is appended. In some examples, a vacuum process may bulk delete for dead tuples. The delete may mark the qualifying entries as invalid and may compact the page. In some examples, a vacuum process may not delete pages. In some examples, the empty space created through deletes may be used by upcoming inserts.

In general, index maintenance module 208 may apply operations, such as the split centroid operation, to split a large partition (e.g., >3× the average-at-create-index partition size) into two smaller partitions. In some examples, index maintenance module 208 may apply the split centroid operation at a non-leaf level of the tree. In some examples, the split centroid operation may create a new or “target” centroid, in which the rows belonging to the old or “source” centroid may be distributed between the source and target centroid depending on their distance from the target centroid. The target centroid entry may be inserted into the same parent node as the source centroid. In some examples, a split operation may only split one partition at a time, and recursive splits required at same or higher levels of the tree may be handled in distinct split operations. In some examples, a split centroid operation may not increase height of the tree, and may be processed in a background process. In some other examples, however, index maintenance module 208 may apply concurrent split processing of multiple partitions of a single index. In some examples, when the dataset has changed multi-fold, incremental maintenance on the vector index may not be sufficient for optimal performance and recall. As such, in some examples, index maintenance module 208 may recreate the index, e.g., a reindex (in the background) may be automatically triggered on a client's behalf based upon certain heuristics (using query performance, recall and dataset changes) without requiring any action from the client.

In an example involving leaf nodes, index scanner 206 may scan a plurality of leaf nodes (e.g., “partitions”) included in an index of database 250. While index scanner 206 scans and/or inspects the plurality of partitions, lock manager 210 may apply a shared lock to each partition from the plurality of partitions that index scanner 206 inspects. In general, the shared lock applied by lock manager 210 may allow query executor 216 to execute concurrent read operations on a partition and prevent executor 216 from executing concurrent write operations on the partition.

In one example, while lock manager 210 applies a shared lock to leaf node p2, index scanner 206 may determine that leaf node p2 is too full. As such, index scanner 206 may select leaf node p2 as a source leaf node (e.g., a source partition) for a split operation. In some examples, selecting a source leaf node may be based on the index maintenance metadata stored in database 250, such as a difference between an average number of vectors per centroid during build and a current vector count for a centroid (in some examples, this may be a single metadata variable stored per index). For example, if the current vector count for a centroid is 3× than that of the average-at-create-time, index scanner 206 may consider the partition a target for split. In some examples, selecting a source leaf node may be based on original vector count and current vector count per centroid, e.g., if the current vector count for a centroid is 2× the original count, index scanner 206 may consider the partition a target for split. In some examples, this may require each centroid to maintain the original vector count. In some examples, selecting a source leaf node may be based on a fixed (constant) targeted count of vectors per partition, e.g., if the current vector count for a centroid is 2× than fixed constant, index scanner 206 may consider the partition a target for split. In some examples, index scanner 206 may iterate over all the vectors in the centroid to count the current number of vectors, and may verify that a partition is not the source or a target of an ongoing split, e.g., by checking the index metadata. Responsive to index scanner 206 determining to apply the maintenance operation to the partition, lock manager 210 may release the shared lock.

In general, index maintenance module 208 may monitor a pin count for a partition (e.g., the pin count may indicate a number of query, insert, and/or vacuum processes that are using the partition). Responsive to determining query executor 216 has finished all concurrent read operations on the partition (e.g., when index maintenance module 208 determines the pin count is equivalent to 1), lock manager 210 may apply a cleanup lock to the target partition. In general, the cleanup lock may prevent query executor 216 from executing concurrent read and write operations on the partition.

In some examples, to identify query overlap with split, lock manager 210 may implement locking, such as a partition lock, between metadata and the query being executed by query executor 216, e.g., for consistent information. In general, when lock manager 210 introduces a lock, the lock may have minimal or no impact for the queries and inserts being executed by query executor 216. In some examples, a preferred method is to set bits on partition pages while a split operation is active, e.g., to indicate source/target status. Bit setting may be the first action, and clearing the last, before completion of a split. This may be efficient for queries but duplicates state (on pages and in metadata). In general, queries may check the partition state using local information.

For example, a query may start a partition scan and note that it is not undergoing a split. A split may start on the partition before the query's partition scan finishes, and the query may miss noting that it visited the source/old partition of an active split. To avoid these problems, queries executed by query executor 216 may require some guarantees/rules with respect to changes to the state of the partition. For example, one option for implementing synchronization guarantees may be to have the partition's start page pinned (since it's static and easily located), and to require old and new bits unsetting for partition's data pages under a cleanup lock. A PostgreSQL vacuum operation may use the cleanup lock to verify no backend pins exist on the page. When pin_count=1, the page may be exclusively locked. The exclusive per-page latch used in (re)setting the partition data page bits may prevent scans from jumping ahead after maintenance acquires it. Another option for implementing synchronization guarantees may be to delay split metadata entry cleanup. Overlapping queries may need split metadata information. Clean up may only occur after all such queries complete (similar to vacuum).

In general, there may be different operations with which concurrency needs to be handled, such as a DML operation (insert/update/delete) and queries on a partition under split or creation or on other partitions, a vacuum operation, and/or a DDL operation. In some examples, such as examples in which vacuum or DDL operations are occurring, lock manager 210 may acquire a “share update exclusive lock,” which may be a lock that only allows concurrent selects or DMLs (no vacuum or schema change allowed), and may prevent any concurrent splits (e.g., in cases where multiple partitions require split).

In some examples, a split operation may sync up with a vacuum operation using status flags and a buffer pin. For instance, the split may retain the pin on the first page of the partition to prevent vacuum from processing the partition. The pin on the first page may be released at the end of the split or in case of errors. The vacuum operation may also work on the similar cleanup lock for every page. The split may acquire a cleanup lock on the start page of the old partition and keep the pin even when it moves ahead of the start page. In some examples, the split partition page scan on the old partition can be done using shared buffer content locks. The new partition pages may use exclusive buffer locks. Since the vacuum may not run on the partitions actively involved in the split, no rows may be deleted from the old partition while split is scanning the partition. Thus, due to the lock, when the vacuum operation acquires the cleanup lock, it may ensure that there is no split running concurrently. In some examples, reads on the old partition may continue as before. The reads landing into the new partition with split-new-partition bit may read the rows from the new partition, and in addition, may read the rows from the old partition. This may prevent missing the rows which are yet to be copied by the split to the new partition. Inserts may be allowed on both old and new partitions. Thus, once the split operation starts, inserts and reads may go to the correct partition.

In some examples, an insert may see only the old or source partition or both, depending on its timing. In some examples, a pinning and cleanup lock-based solution may be implemented, which may be based on PostgreSQL's hash index split algorithm, and may prevent concurrent index maintenance and insertion in the centroid layer. Inserts typically read root/centroid layer pages sequentially, with a latch and pin on the current page. This solution may require the inserter to maintain a pin (not latch) on each layer's start page during centroid qualification. The split operation may protect new centroid insertion with a cleanup lock on the parent centroid's start page, and the lock may be released after centroid insertion. The split operation may wait for the cleanup lock, prioritizing inserts. When the split acquires the lock, it may be prepared, and thus only centroid insertion may remain, ensuring a bounded wait for subsequent inserts. A maintenance window may further reduce potential insert blockage.

Thus, in general, to ensure consistency and concurrency safety while splitting partitions in a live system, the split centroid operation by index maintenance module 208 may specifically compute a target partition, e.g., new leaf node p5 or new leaf node p6, using shared locks applied by lock manager 210, then take a cleanup lock applied by lock manager 210 on a first page of the parent page chain to wait out active accessors in the subtree. The cleanup lock may be a non-transactional lock used by processes such as vacuum. When this lock is acquired on a buffer, the pin count may be 1, and the page may be locked in an “exclusive” mode. This lock may ensure that there are no in-flight backends that have pinned a page. Once lock manager 210 applies the lock, index maintenance module 208 may insert the target partition and mark it with a “split-new-partition” bit. A mapping entry for the {source, target} partitions may be inserted in the index metadata to track the ongoing split. These entries may logically commit the decision to split the partition. Even when interrupted, index maintenance module 208 may continue the split operation incrementally after restart to copy the remaining rows to the target partition.

While lock manager 210 is applying the cleanup lock to the partition, index maintenance module 208 may apply the maintenance operation to the partition. At the start of a split (e.g., during a “start state”) operation by index maintenance module 208, all rows included in source leaf node p2 may reside in source leaf node p2, and the new leaf node (e.g., target partition) “p5” may not exist yet. Then, during a “copy state,” all rows included in source leaf node p2 may still reside in source leaf node p2, with some rows included in source leaf node p2 being duplicated in new leaf node p5. The copy state may span from the start of the split to the completion of row movement. In some examples, a leaf node may point to another leaf node, e.g., the tree-based index structure included in database 250 may include linked leaf nodes. That is, in some examples, a linked list connection may exist between leaf pages to facilitate faster, sequential scanning of sorted data. Thus, in some examples, source leaf node p2 may point to leaf node p3. As such, during the copy state, all rows included in leaf node p3 may still reside in leaf node p3, with some rows included in leaf node p3 being duplicated in another new leaf node “p6,” in which new leaf node p5 may point to new leaf node p6. In some examples, the split centroid operation may scan the rows from the source partition, and every index tuple may be compared to both the source and target partition. If an index is closer to the target partition, it may be inserted into the target partition. Queries on the target partition may notice the split-new-partition bit on the first page of the target partition, and then scan the source partition to ensure that the rows which are yet to be moved are not missed.

In general, concurrency issues may arise when a query overlaps with the copy and delete states and visits partitions in split source, split target, or split source cleanup states. For example, a query may find duplicate data points if it visits both partitions participating in the split while the split was in progress. To check for the possibility of split-introduced duplicates or the possibility of observing duplicate rows, the query may want to know whether it visited both partitions involved in the split and whether the source partition was in split source or split source cleanup state. To identify the partition state, the partition page bits marking technique, i.e., setting a bit on the partitions which are undergoing a split, may be used. The scans may note if a partition with a split related bit on was observed. Since the scans and the maintenance can interleave, a bit may be set on all pages of a partition. In some examples, a query can be flagged as potentially having duplicates due to concurrent splits even when it doesn't scan split related partitions. In some examples, this may be fixed by having the query take note of the page LSN of the metadata page at the start of the index scan and then check it again at the end. If the LSN has changed, the query can assume a concurrent split occurred and verify that no splits happened in parallel with the query. In some examples, a query can indicate whether it scanned any partition with the “old_partition” bit set or a partition with the “new_partition” bit set. This may not guarantee that it scanned the exact pair of partitions involved in the split. For example, it may have scanned the old partition from one split and the new partition from another split. In this scenario, while still narrower than simply scanning any partition, may include scanning a partition involved in the split. In some examples, a query may try to verify if it scanned a pair of partitions from the same split. In some examples, queries visiting a split target partition may miss rows not yet moved. Query redirection, where the query also reads the source partition, may solve this issue. Due to non-atomic row movement (i.e., when partition is considered as a whole), new partition queries might miss rows, making redirection necessary. A query may detect new partition visits via the new partition bit or metadata. In some examples, this may require a mapping to the old partition, thus relying on metadata. Queries behind a maintenance scan may not jump ahead of it due to latch incompatibility. Two maintenance scans may exist for new partitions: one for inserting rows, the other to clear the new partition bit. Missing rows may only occur during the split target state (e.g., when the new_partition bit is set). Such a query may need the corresponding old partition information, which it may obtain consistently from the metadata, allowing it to scan the old partition as well.

In an example in which the system restarts (or index maintenance module 208 has an error) while the split is in progress, then the target partition may still have the split_new_partition bit set. Index maintenance module 208 may retry the interrupted split using persisted metadata information as a starting point. To avoid duplicate inserts, index maintenance module 208 may build a hash table on the target partition. The (restarted) scan of the source partition by index scanner 206 may consult the hash table before deciding whether to copy the row to the target partition. To retry interrupted cleanup, the mapping stored in the global metadata can be used to get the value of the target partition post-restart. Once index maintenance module 208 knows the target partition value, it may use it in both cleanups and row copying to the target partition. In some examples, only index maintenance module 208 may retry the split copy phase, as it may require page allocations. In some examples, index maintenance module 208 may handle the (interrupted) cleanup.

After the copy state, e.g., during a “delete state,” all original rows and some new rows may be included in the source leaf node, while all new rows may be included in the new leaf node. The delete state may span from the start of deletion from the source leaf node to its completion. Specifically, when index scanner 206 completes the scan of all the rows in the partition the split centroid operation, it may clear the split-new-partition bit on the target partition and add the split-cleanup-required bit on the source partition in a single Write-Ahead Logging (WAL) record. The WAL record may mark the successful completion of the split movement. In some examples, for WAL logging, new pages created as part of the SplitCentroid operation may log full page images. The updates in the parent node may automatically use delta update generic WAL records similar to existing insert page update workflows. The insert of a new centroid may be handled in a similar way as a leaf page insert. In some examples, a split centroid operation may require multiple log records.

The “cleanup” required on the source partition may involve deleting rows which are copied to the target partition. Once the cleanup process completes one successful scan of the source partition, it may turn off the cleanup required bit, thus marking the full completion of the cleanup. Then, during the “completion state,” both the source leaf node and the target leaf node may contain only their respective rows. Specifically, a successful cleanup scan of the source partition may indicate that the duplicates in the target partition have been removed.

As such, the split centroid operation facilitated by index maintenance module 208 may help keep the average number of rows per partition in check to bound the worst-case performance degradation for a growing index, while providing a means for handling transient states during maintenance operations. That is, the techniques described herein may provide solutions for addressing the challenges of handling concurrent queries during maintenance operations. By supporting safer and more robust splitting and updating of large centroids, the techniques described herein may facilitate better adaptation of dynamic datasets in operational databases, thus helping to maintain performance and recall quality of vector search queries as the underlying data evolves.

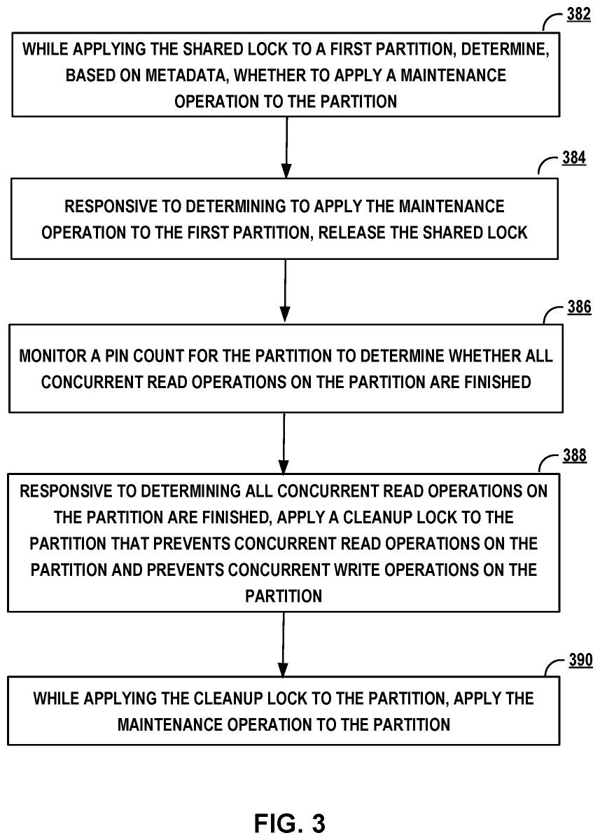

FIG. 3 is a flowchart illustrating an example operation of a computing system for applying index maintenance operations, in accordance with one or more techniques of this disclosure. For clarity, FIG. 3 is described with respect to FIG. 2.

While lock manager 210 applies a shared lock to a first partition, index scanner 206 determines, based on metadata stored in database 250, whether index maintenance module 208 should apply a maintenance operation to the first partition (382). In some examples, the shared lock allows query executor 216 to execute concurrent read operations on the first partition and prevents query executor 216 from executing concurrent write operations on the first partition. Responsive to determining index maintenance module 208 should apply the maintenance operation to the first partition, lock manager 210 releases the shared lock (384). Index maintenance module 208 monitors a pin count for the first partition to determine whether all concurrent read operations on the first partition being executed by query executor 216 are finished (386). Responsive to determining all concurrent read operations on the first partition are finished, lock manager 210 applies a cleanup lock to the first partition (388). In some examples, the cleanup lock prevents concurrent read operations on the first partition and prevents concurrent write operations on the first partition. While lock manager 210 applies cleanup lock to the first partition, Index maintenance module 208 applies the maintenance operation to the first partition (390).

This disclosure includes the following examples:
Example 1: A method includes: while applying a shared lock to a first partition from a plurality of partitions included in an index, determining, by the computing system, and based on metadata, whether to apply a maintenance operation to the first partition; and responsive to determining to apply the maintenance operation to the first partition: releasing, by the computing system, the shared lock; and while applying a cleanup lock to the first partition, applying, by the computing system, the maintenance operation to the first partition, wherein the cleanup lock prevents concurrent read operations on the first partition and prevents concurrent write operations on the first partition.
Example 2: The method of example 1, wherein the shared lock allows concurrent read operations on the first partition and prevents concurrent write operations on the first partition.
Example 3: The method of example 1 or 2, further comprising: monitoring, by the computing system, a pin count for the first partition to determine whether all concurrent read operations on the first partition are finished, wherein applying the cleanup lock is in response to determining all concurrent read operations on the first partition are finished.
Example 4: The method of any of examples 1 through 3, wherein the maintenance operation is a split operation or an update operation.
Example 5: The method of any of examples 1 through 4, wherein applying the maintenance operation to the first partition further comprises: setting, by the computing system, a bit on the first partition to indicate a maintenance status of the first partition.
Example 6: The method of any of examples 1 through 5, wherein the metadata includes data indicative of an average number of vectors included in each partition from the plurality of partitions during a build period and data indicative of a current number of vectors included in the first partition, wherein determining whether to apply the maintenance operation to the first partition further comprises: determining, by the computing system, whether the current number of vectors included in the first partition is at least three times larger than the average number of vectors included in each partition from the plurality of partitions during the build period; and responsive to determining the current number of vectors included in the first partition is at least three times larger than the average number of vectors, determining to apply the maintenance operation to the first partition.
Example 7: The method of any of examples 1 through 6, wherein the metadata is indicative of all maintenance operations being applied to the plurality of partitions included in the index.
Example 8: The method of examples 1 through 7, wherein the metadata is indicative of a current state for a respective partition from the plurality of partitions.
Example 9: The method of example 8, wherein the current state is one of an unchanged state, a split source state, a split target state, and a split source cleanup state.
Example 10: A computing system includes one or more processors; and one or more storage devices that store instructions, wherein the instructions, when executed by the one or more processors, cause the one or more processors to: while applying a shared lock to a first partition from a plurality of partitions included in an index, determine, based on metadata, whether to apply a maintenance operation to the first partition; and responsive to determining to apply the maintenance operation to the first partition: release the shared lock; and while applying a cleanup lock to the first partition, apply the maintenance operation to the first partition, wherein the cleanup lock prevents concurrent read operations on the first partition and prevents concurrent write operations on the first partition.
Example 11: The computing system of example 10, wherein the shared lock allows concurrent read operations on the first partition and prevents concurrent write operations on the first partition.
Example 12: The computing system of example 10 or 11, wherein the instructions further cause the one or more processors to monitor a pin count for the first partition to determine whether all concurrent read operations on the first partition are finished, and wherein the instructions further cause the one or more processors to apply the cleanup lock in response to determining all concurrent read operations on the first partition are finished.
Example 13: The computing system of any of examples 10 through 12, wherein the maintenance operation is a split operation or an update operation.
Example 14: The computing system of any of examples 10 through 13, wherein to apply the maintenance operation to the first partition, the instructions further cause the one or more processors to set a bit on the first partition to indicate a maintenance status of the first partition.
Example 15: The computing system of any of examples 10 through 14, wherein the metadata includes data indicative of an average number of vectors included in each partition from the plurality of partitions during a build period and data indicative of a current number of vectors included in the first partition, wherein to determine whether to apply the maintenance operation to the first partition, the instructions further cause the one or more processors to: determine whether the current number of vectors included in the first partition is at least three times larger than the average number of vectors included in each partition from the plurality of partitions during the build period; and responsive to determining the current number of vectors included in the first partition is at least three times larger than the average number of vectors, determine to apply the maintenance operation to the first partition.
Example 16: The computing system of any of examples 10 through 15, wherein the metadata is indicative of all maintenance operations being applied to the plurality of partitions included in the index.
Example 17: The computing system of any of examples 10 through 16, wherein the metadata is indicative of a current state for a respective partition from the plurality of partitions.
Example 18: The computing system of example 17, wherein the current state is one of an unchanged state, a split source state, a split target state, and a split source cleanup state.
Example 19: A non-transitory computer-readable storage medium encoded with instructions that, when executed by one or more processors, cause one or more processors to: while applying a shared lock to a first partition from a plurality of partitions included in an index, determine, based on metadata, whether to apply a maintenance operation to the first partition; and responsive to determining to apply the maintenance operation to the first partition: release the shared lock; and while applying a cleanup lock to the first partition, apply the maintenance operation to the first partition, wherein the cleanup lock prevents concurrent read operations on the first partition and prevents concurrent write operations on the first partition.
Example 20: The non-transitory computer-readable storage medium of example 19, wherein the shared lock allows concurrent read operations on the first partition and prevents concurrent write operations on the first partition.
Example 21: The non-transitory computer-readable storage medium of example 19 or 20, wherein the instructions further cause the one or more processors to monitor a pin count for the first partition to determine whether all concurrent read operations on the first partition are finished, and wherein the instructions further cause the one or more processors to apply the cleanup lock in response to determining all concurrent read operations on the first partition are finished.
Example 22: The non-transitory computer-readable storage medium of any of examples 19 through 21, wherein the maintenance operation is a split operation or an update operation.
Example 23: The non-transitory computer-readable storage medium of any of examples 19 through 22, wherein to apply the maintenance operation to the first partition, the instructions further cause the one or more processors to set a bit on the first partition to indicate a maintenance status of the first partition.
Example 24: The non-transitory computer-readable storage medium of any of examples 19 through 23, wherein the metadata includes data indicative of an average number of vectors included in each partition from the plurality of partitions during a build period and data indicative of a current number of vectors included in the first partition, wherein to determine whether to apply the maintenance operation to the first partition, the instructions further cause the one or more processors to: determine whether the current number of vectors included in the first partition is at least three times larger than the average number of vectors included in each partition from the plurality of partitions during the build period; and responsive to determining the current number of vectors included in the first partition is at least three times larger than the average number of vectors, determine to apply the maintenance operation to the first partition.
Example 25: The non-transitory computer-readable storage medium of any of examples 19 through 24, wherein the metadata is indicative of all maintenance operations being applied to the plurality of partitions included in the index.
Example 26: The non-transitory computer-readable storage medium of any of examples 19 through 25, wherein the metadata is indicative of a current state for a respective partition from the plurality of partitions.
Example 27: The non-transitory computer-readable storage medium of example 26, wherein the current state is one of an unchanged state, a split source state, a split target state, and a split source cleanup state.
Example 28: A computer program product for automatic maintenance of vector indexes, the computer program product comprising instructions that, when executed by one or more processors, cause the one or more processors to: while applying a shared lock to a first partition from a plurality of partitions included in an index, determine, based on metadata, whether to apply a maintenance operation to the first partition; and responsive to determining to apply the maintenance operation to the first partition: release the shared lock; and while applying a cleanup lock to the first partition, apply the maintenance operation to the first partition, wherein the cleanup lock prevents concurrent read operations on the first partition and prevents concurrent write operations on the first partition.
Example 29: The computer program product of example 28, wherein the shared lock allows concurrent read operations on the first partition and prevents concurrent write operations on the first partition.
Example 30: The computer program product of example 29, wherein the instructions further cause the one or more processors to monitor a pin count for the first partition to determine whether all concurrent read operations on the first partition are finished, and wherein the instructions further cause the one or more processors to apply the cleanup lock in response to determining all concurrent read operations on the first partition are finished.
Example 31: The computer program product of any of examples 28 through 30, wherein the maintenance operation is a split operation or an update operation.
Example 32: The computer program product of any of examples 28 through 31, wherein to apply the maintenance operation to the first partition, the instructions further cause the one or more processors to set a bit on the first partition to indicate a maintenance status of the first partition.
Example 33: The computer program product of any of examples 28 through 33, wherein the metadata includes data indicative of an average number of vectors included in each partition from the plurality of partitions during a build period and data indicative of a current number of vectors included in the first partition, wherein to determine whether to apply the maintenance operation to the first partition, the instructions further cause the one or more processors to: determine whether the current number of vectors included in the first partition is at least three times larger than the average number of vectors included in each partition from the plurality of partitions during the build period; and responsive to determining the current number of vectors included in the first partition is at least three times larger than the average number of vectors, determine to apply the maintenance operation to the first partition.
Example 34: The computer program product of any of examples 28 through 33, wherein the metadata is indicative of all maintenance operations being applied to the plurality of partitions included in the index.
Example 35: The computer program product of any of examples 28 through 34, wherein the metadata is indicative of a current state for a respective partition from the plurality of partitions.
Example 36: The computer program product of example 35, wherein the current state is one of an unchanged state, a split source state, a split target state, and a split source cleanup state.
Example 37: A computing device comprising means for performing any combination of the methods of examples 1-9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
while applying a shared lock to a first partition from a plurality of partitions included in an index, determining, by a computing system, and based on metadata, whether to apply a maintenance operation to the first partition; and
responsive to determining to apply the maintenance operation to the first partition:
releasing, by the computing system, the shared lock; and
while applying a cleanup lock to the first partition, applying, by the computing system, the maintenance operation to the first partition, wherein the cleanup lock prevents concurrent read operations on the first partition and prevents concurrent write operations on the first partition.

2. The method of claim 1, wherein the shared lock allows concurrent read operations on the first partition and prevents concurrent write operations on the first partition.

3. The method of claim 1, further comprising:
monitoring, by the computing system, a pin count for the first partition to determine whether all concurrent read operations on the first partition are finished,
wherein applying the cleanup lock is in response to determining all concurrent read operations on the first partition are finished.

4. The method of claim 1, wherein the maintenance operation is a split operation or an update operation.

5. The method of claim 1, wherein applying the maintenance operation to the first partition further comprises:
setting, by the computing system, a bit on the first partition to indicate a maintenance status of the first partition.

6. The method of claim 1, wherein the metadata includes data indicative of an average number of vectors included in each partition from the plurality of partitions during a build period and data indicative of a current number of vectors included in the first partition, wherein determining whether to apply the maintenance operation to the first partition further comprises:
determining, by the computing system, whether the current number of vectors included in the first partition is at least three times larger than the average number of vectors included in each partition from the plurality of partitions during the build period; and
responsive to determining the current number of vectors included in the first partition is at least three times larger than the average number of vectors, determining to apply the maintenance operation to the first partition.

7. The method of claim 1, wherein the metadata is indicative of all maintenance operations being applied to the plurality of partitions included in the index.

8. The method of claim 1, wherein the metadata is indicative of a current state for a respective partition from the plurality of partitions.

9. The method of claim 8, wherein the current state is one of an unchanged state, a split source state, a split target state, and a split source cleanup state.

10. A computing system comprising:
one or more processors; and
one or more storage devices that store instructions, wherein the instructions, when executed by the one or more processors, cause the one or more processors to:
while applying a shared lock to a first partition from a plurality of partitions included in an index, determine, based on metadata, whether to apply a maintenance operation to the first partition; and
responsive to determining to apply the maintenance operation to the first partition:
release the shared lock; and
while applying a cleanup lock to the first partition, apply the maintenance operation to the first partition, wherein the cleanup lock prevents concurrent read operations on the first partition and prevents concurrent write operations on the first partition.

11. The computing system of claim 10, wherein the shared lock allows concurrent read operations on the first partition and prevents concurrent write operations on the first partition.

12. The computing system of claim 10, wherein the instructions further cause the one or more processors to monitor a pin count for the first partition to determine whether all concurrent read operations on the first partition are finished, and wherein the instructions further cause the one or more processors to apply the cleanup lock in response to determining all concurrent read operations on the first partition are finished.

13. The computing system of claim 10, wherein the maintenance operation is a split operation or an update operation.

14. The computing system of claim 10, wherein to apply the maintenance operation to the first partition, the instructions further cause the one or more processors to set a bit on the first partition to indicate a maintenance status of the first partition.

15. The computing system of claim 10, wherein the metadata includes data indicative of an average number of vectors included in each partition from the plurality of partitions during a build period and data indicative of a current number of vectors included in the first partition, wherein to determine whether to apply the maintenance operation to the first partition, the instructions further cause the one or more processors to:
determine whether the current number of vectors included in the first partition is at least three times larger than the average number of vectors included in each partition from the plurality of partitions during the build period; and
responsive to determining the current number of vectors included in the first partition is at least three times larger than the average number of vectors, determine to apply the maintenance operation to the first partition.

16. The computing system of claim 10, wherein the metadata is indicative of all maintenance operations being applied to the plurality of partitions included in the index.

17. The computing system of claim 10, wherein the metadata is indicative of a current state for a respective partition from the plurality of partitions.

18. The computing system of claim 17, wherein the current state is one of an unchanged state, a split source state, a split target state, and a split source cleanup state.

19. A non-transitory computer-readable storage medium encoded with instructions that, when executed by one or more processors, cause one or more processors to:
while applying a shared lock to a first partition from a plurality of partitions included in an index, determine, based on metadata, whether to apply a maintenance operation to the first partition; and
responsive to determining to apply the maintenance operation to the first partition:
release the shared lock; and
while applying a cleanup lock to the first partition, apply the maintenance operation to the first partition, wherein the cleanup lock prevents concurrent read operations on the first partition and prevents concurrent write operations on the first partition.

20. The non-transitory computer-readable storage medium of claim 19, wherein the shared lock allows concurrent read operations on the first partition and prevents concurrent write operations on the first partition.
